(19) United States
(12) Patent Application Publication
(10) Pub. No.: US 2023/0234730 A1
(43) Pub. Date: Jul. 27, 2023

(54) UNMANNED AIRCRAFT

(71) Applicant: Sony Group Corporation, Tokyo (JP)

(72) Inventor: Yosuke MATSUZAKI, Tokyo (JP)

(73) Assignee: Sony Group Corporation, Tokyo (JP)

(21) Appl. No.: 18/002,276

(22) PCT Filed: Jun. 16, 2021
(86) PCT No.: PCT/JP2021/022777

§ 371 Date: Dec. 19, 2022

(30) Foreign Application Priority Data
Jun. 29, 2020 (JP) 2020-111647

(51) Int. Cl. B64U 20/70; B64U 10/14; B64U 20/80; G01C 5/06

(52) U.S. Cl. CPC B64U 20/70; B64U 10/14; B64U 20/80; G01C 5/06

(57) ABSTRACT

The present disclosure relates to an unmanned aircraft capable of suitably limiting a variation in pressure altitude.

The unmanned aircraft includes a housing that constitutes a main body, one barometric pressure sensor that is provided in one space formed inside the housing, and four or more openings that have substantially the same opening area, the four or more openings being arranged in a balanced manner over an entire circumference of a side portion of the housing. The present disclosure can be applied to a drone including a barometric pressure sensor.

### TECHNICAL FIELD

The present disclosure relates to an unmanned aircraft, and particularly to an unmanned aircraft capable of suitably limiting a variation in pressure altitude.

### BACKGROUND ART

Conventionally, some small unmanned aircrafts (so-called drones) are equipped with a barometric pressure sensor for estimating a flight altitude on the basis of barometric pressure.

Patent Document 1 discloses a measurement flight vehicle including a housing that accommodates a measurement unit such as a barometer or a thermometer. In the housing, the barometer is shielded by a shield portion, and a plurality of vent holes is arranged around the shield portion in a side wall portion of the housing, and therefore barometric pressure can be accurately measured.

### CITATION LIST

### Patent Document

### Patent Document 1: Japanese Patent Application Laid-Open No. 2013-189036

### SUMMARY OF THE INVENTION

### Problems to be Solved by the Invention

There has been a possibility that flight altitude (pressure altitude) estimated on the basis of the output value of the barometric pressure sensor fluctuates due to a speed change, an attitude change, or the like of the drone in flight.

The present disclosure has been made in view of such a situation, and enables a variation in pressure altitude to be suitably limited.

### Solutions to Problems

An unmanned aircraft of the present disclosure is an unmanned aircraft including: a housing that constitutes a main body; one barometric pressure sensor that is provided in one space formed inside the housing;

and four or more openings that have substantially the same opening area, the four or more openings being arranged in a balanced manner over an entire circumference of a side portion of the housing.

In the present disclosure, one barometric pressure sensor is provided in one space formed inside a housing that constitutes a main body, and four or more openings having substantially the same opening area are arranged in a balanced manner over an entire circumference of a side portion of the housing.

### BRIEF DESCRIPTION OF DRAWINGS

FIG. 1 is a perspective view illustrating an appearance of a drone to which the technology according to the present disclosure is applied.

FIG. 2 is a view illustrating a configuration of a housing constituting a main body of the drone.

FIG. 3 is a view illustrating the configuration of the housing constituting the main body of the drone.

FIG. 4 is a view for explaining the configuration inside the housing.

FIG. 5 is a view illustrating another configuration example of the housing.

FIG. 6 is a view illustrating another configuration example of the housing.

FIG. 7 is a view illustrating another configuration example of the housing.

FIG. 8 is a view for explaining arrangement places of openings.

FIG. 9 is a view for explaining the arrangement places of the openings.

FIG. 10 is a diagram for explaining an altitude change in a case where the opening area is non-uniform.

FIG. 11 is a diagram for explaining an altitude change in a case where the opening area is uniform.

FIG. 12 is a diagram illustrating actual measurement values of pressure altitude in a conventional drone.

FIG. 13 is a diagram illustrating actual measurement values of pressure altitude in the drone according to the present embodiment.

FIG. 14 is a view illustrating modifications of the housing.

FIG. 15 is a view illustrating a modification of the housing.

FIG. 16 is a view illustrating a modification of the housing.

FIG. 17 is a view illustrating a modification of the housing.

### MODE FOR CARRYING OUT THE INVENTION

Hereinafter, an embodiment for implementing the present disclosure (hereinafter, referred to as an embodiment) will be described. Note that the description will be given in the following order.

1. Variation in pressure altitude and request for improvement thereof

2. Appearance of drone

3. Configuration of housing

4. Arrangement place and opening area of opening

5. Modifications

### 1. Variation in Pressure Altitude and Request for Improvement Thereof

Conventionally, some drones are equipped with a barometric pressure sensor for estimating a flight altitude on the basis of barometric pressure.

There has been a possibility that flight altitude (pressure altitude) estimated on the basis of the output value of the barometric pressure sensor fluctuates due to a speed change, an attitude change, or the like of the drone in flight. A variation in the pressure altitude can be absorbed to some extent by numerical adjustment; however, in a case where the variation is great, accuracy of numerical adjustment becomes low.

In contrast, it is required to reduce the influence of disturbance such as a speed change or an attitude change of the drone, and to limit a variation in the pressure altitude to a behavior to which numerical adjustment is made easily.

Furthermore, in recent years, there is a drone that estimates pressure altitude by averaging output values of a plurality of barometric pressure sensors and offsetting errors due to wind pressure during flight. However, even in such a configuration, it is not easy to realize the above-described requests.

Hereinafter, an embodiment for realizing the above-described requests will be described.

### 2. Appearance of Drone

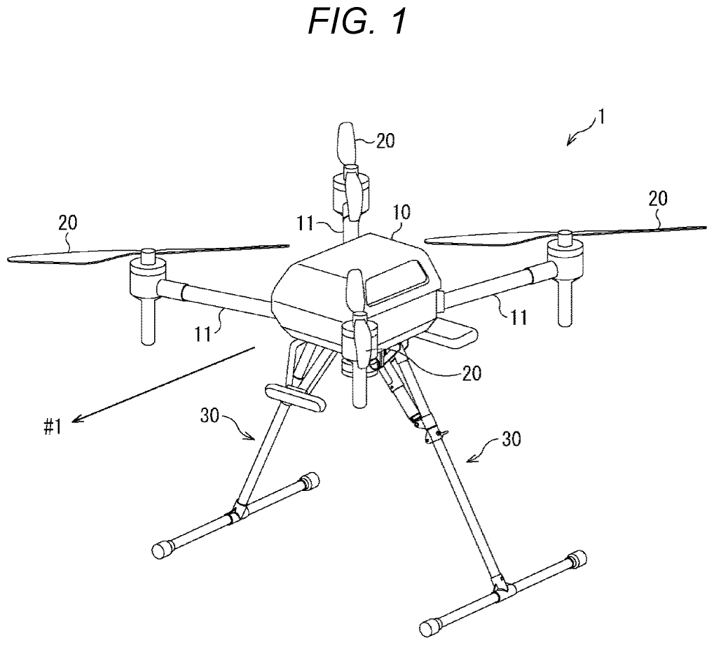

FIG. 1 is a perspective view illustrating an appearance of a drone that is an unmanned aircraft to which the technology according to the present disclosure (present technology) is applied.

A drone 1 illustrated in FIG. 1 can move in any direction by flight by remote control or autonomous flight; however, it is assumed that the drone 1 flies with the direction indicated by an arrow #1 in the drawing as a forward direction (traveling direction according to a forward flight instruction). That is, FIG. 1 illustrates the drone 1 viewed from diagonally forward left.

The drone 1 includes a main body 10 and a plurality of (four in the present embodiment) frame portions 11 that extends from the main body 10. Furthermore, the drone 1 includes a propeller 20 at a front end (end portion that is not on the main body 10 side) of the frame portion 11. The propeller 20 is rotated by a motor, not illustrated, mounted inside the front end of the frame portion 11.

The drone 1 includes a plurality of (two in the present embodiment) landing devices 30 for supporting the main body 10 on the ground, the plurality of landing devices 30 being provided at a bottom portion of the main body 10. The landing device 30 has a length that prevents a camera for aerial shooting, not illustrated, mounted on the bottom portion of the main body 10 of the drone 1 from contacting the ground at the time of landing of the drone 1. Furthermore, the landing device 30 is able to be raised and lowered so as not to disturb imaging by the camera for aerial shooting while the drone 1 is flying.

Various electric component units and the like are mounted inside the main body 10 and the frame portions 11. Specifically, a receiving unit, a controller, a sensor unit, a battery unit, a cooling fan, and the like are mounted inside the main body 10. A drive control unit that controls driving of the motor which rotates the propeller 20, and the like are mounted inside the frame portion 11.

### 3. Configuration of Housing

Next, the configuration of a housing constituting the main body 10 of the drone 1 will be described.

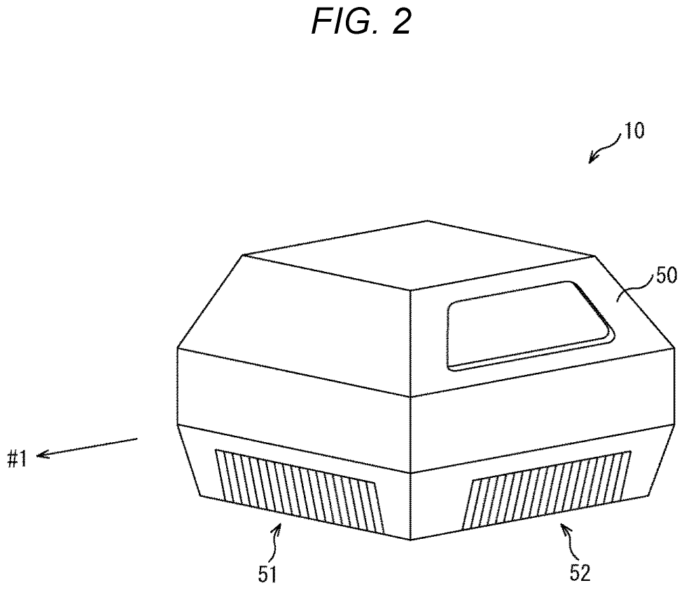

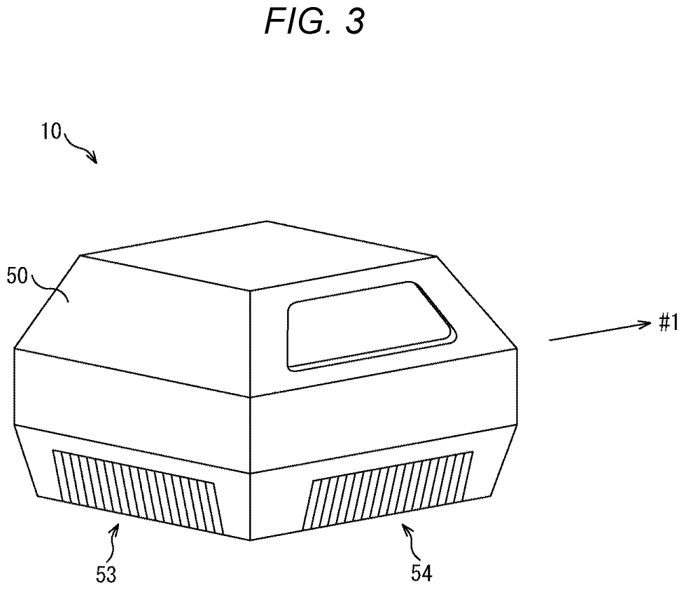

FIGS. 2 and 3 are views illustrating the configuration of the housing constituting the main body 10 of the drone 1. FIG. 2 illustrates the main body 10 of the drone 1 viewed from diagonally forward left, and FIG. 3 illustrates the main body 10 of the drone 1 viewed from diagonally backward right.

The housing 50 constituting the main body 10 of the drone 1 is formed in a rectangular shape in top view, and has rectangular top and bottom surfaces, and side surfaces facing the front, rear, left, and right. In the side portion (side surfaces) of the housing 50, four openings having substantially the same opening area and arranged in a balanced manner over the entire circumference are provided.

As will be described later, a barometric pressure sensor for estimating pressure altitude is provided in a space formed inside the housing 50, and ventilation between the outside of the housing 50 and the space formed inside the housing 50 is performed through the openings. The openings are arranged at locations (specifically, at the front, rear, left, and right of the housing 50) where ventilation can be performed in at least four directions based on the traveling direction of the drone 1 in flight.

Specifically, each of the side surfaces at the front, rear, left, and right of the housing 50 includes three surfaces, that is, a vertical surface substantially vertical to a horizontal plane, an upper slope inclined from an upper end of the vertical surface toward the top surface, and a lower slope inclined from a lower end of the vertical surface toward the bottom surface.

As illustrated in FIG. 2, an opening 51 is arranged in the front side surface (lower slope of the front side surface) of the housing 50, and an opening 52 is arranged in the left side surface (lower slope of the left side surface) of the housing 50. Furthermore, as illustrated in FIG. 3, an opening 53 is arranged in the rear side surface (lower slope of the rear side surface) of the housing 50, and an opening 54 is arranged in the right side surface (lower slope of the right side surface) of the housing 50.

The openings 51 to 54 have the same opening area and the same shape. Furthermore, each of the openings 51 to 54 has a lattice cover that covers the opening surface thereof. In FIGS. 2 and 3, the cover that covers each of the opening surfaces of the openings 51 to 54 is a vertical lattice cover, but may be a horizontal-lattice cover or a cross-lattice cover. Furthermore, each of the opening surfaces of the openings 51 to 54 may be opened without being covered with a lattice cover.

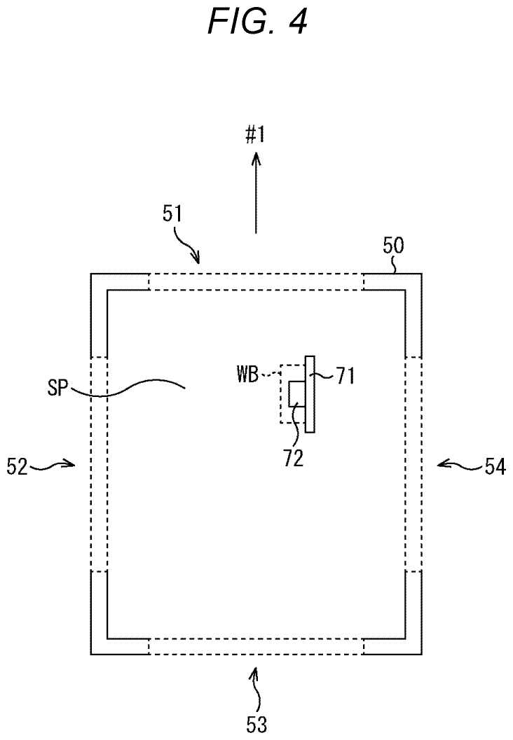

Next, the configuration inside the housing 50 will be described with reference to FIG. 4. FIG. 4 is a top view illustrating the configuration inside the housing 50.

One space SP is formed inside the housing 50. In the space SP, one barometric pressure sensor 72 mounted on a substrate 71 is provided.

A windproof member WB including sponge is provided around the barometric pressure sensor 72 so as to cover entirety of the barometric pressure sensor 72. The windproof member WB may be provided so as to cover part of the barometric pressure sensor 72. Furthermore, the windproof member WB may include a case having a vent hole. In this case, the case included in the windproof member WB includes metal, resin, fiber, or the like.

Note that although not illustrated, the receiving unit, the controller, the battery unit, the cooling fan, and the like described above are also provided in the space SP. In the space SP, the barometric pressure sensor 72 (substrate 71) is provided at any location; however, for example, the barometric pressure sensor 72 is preferably provided at a location not affected by wind from the cooling fan.

### Other Configuration Examples of Housing

The housing constituting the main body 10 of the drone 1 to which the present technology is applied is not limited to the above-described configuration, and it is sufficient if the housing has four or more surfaces continuous in the entire circumferential direction of the side portion thereof, and openings are arranged at least side surfaces at the front, rear, left, and right of the housing.

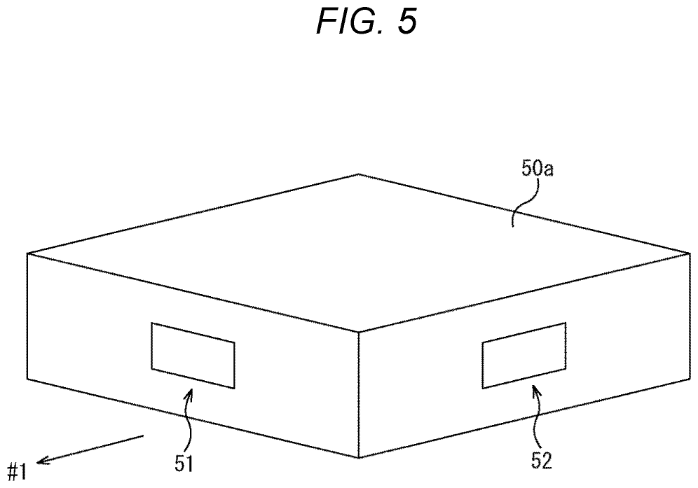

For example, the housing constituting the main body 10 of the drone 1 to which the present technology is applied can adopt a configuration as illustrated in FIG. 5.

A housing 50a illustrated in FIG. 5 is formed in a rectangular shape, specifically, a substantially square shape in top view, and has substantially square top and bottom surfaces, and four side surfaces facing the front, rear, left, and right. Specifically, the side surfaces at the front, rear, left, and right of the housing 50a each include a vertical surface substantially vertical to a horizontal plane.

As illustrated in FIG. 5, an opening 51 is arranged in the front side surface of the housing 50a, and an opening 52 is arranged in the left side surface of the housing 50a. Furthermore, although not illustrated, an opening 53 is arranged in the rear side surface of the housing 50a, and an opening 54 is arranged in the right side surface of the housing 50a.

The openings 51 to 54 have the same opening area and the same shape. Furthermore, the openings 51 to 54 are arranged at the same location, such as substantially the center, in the side surfaces at the front, rear, left, and right.

Note that, in the following description, it is assumed that the openings arranged in the side surfaces and the like of the housing each have a rectangular shape, but may have another shape such as a circular shape or an elliptical shape. Furthermore, the positions of the openings in the side surfaces of the housing may be different (positions shifted from each other) in the vertical direction (height direction) or the left-right direction (horizontal direction).

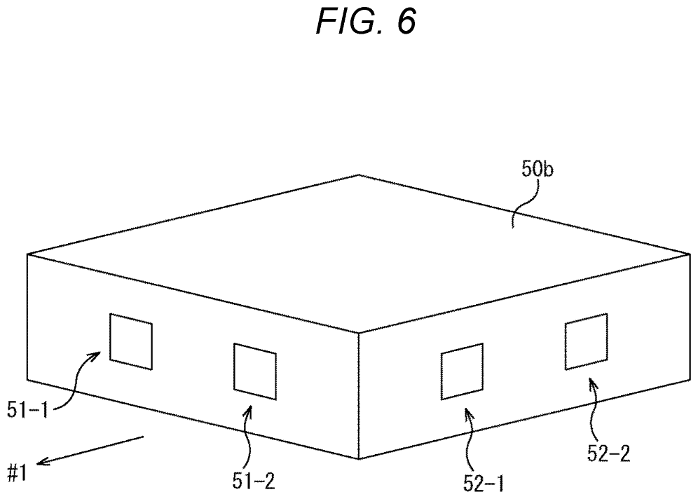

Furthermore, although one of the openings 51 to 54 is arranged in each of the side surfaces at the front, rear, left, and right, it is sufficient if the same number of openings are arranged in each of the side surfaces. For example, as illustrated in FIG. 6, two openings may be arranged in each of the side surfaces at the front, rear, left, and right.

Also a housing 50b illustrated in FIG. 6 is formed in a substantially square shape in top view, and has substantially square top and bottom surfaces, and four side surfaces facing the front, rear, left, and right.

As illustrated in FIG. 6, openings 51-1, 51-2 are arranged in the front side surface of the housing 50b, and openings 52-1, 52-2 are arranged in the left side surface of the housing 50b. Furthermore, although not illustrated, openings 53-1, 53-2 are arranged in the rear side surface of the housing 50b, and openings 54-1, 54-2 are arranged in the right side surface of the housing 50b.

The openings 51-1, 51-2 to 54-1, 54-2 have the same opening area and the same shape. Furthermore, the openings 51-1, 51-2 to 54-1, 54-2 are arranged at the same location in the side surfaces at the front, rear, left, and right.

Note that in the example of FIG. 6, although two openings are arranged in each of the side surfaces at the front, rear, left, and right, it is sufficient if the same number, which is three or more, of openings are arranged in each of the side surfaces.

Furthermore, it is sufficient if the opening area in each of the side surfaces at the front, rear, left, and right is the same, even if the number of openings arranged in each of the side surfaces is different from one another. For example, one opening of 20 mm² may be arranged in each of the front side surface and the left and right side surfaces, and two openings of 10 mm² each may be arranged in the rear side surface.

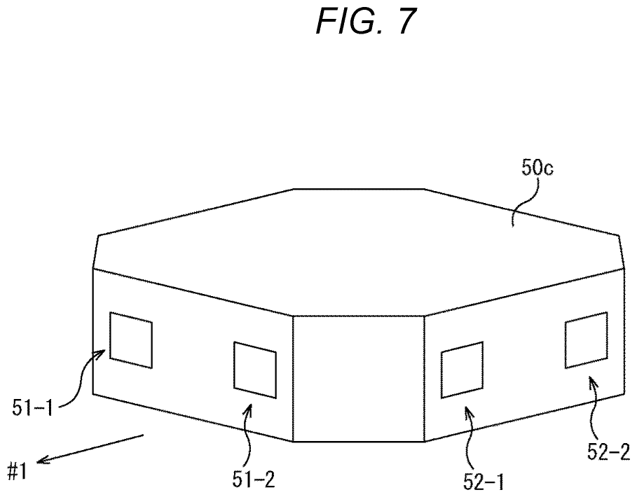

In the above description, it is assumed that the housing has four surfaces continuous in the entire circumferential direction of the side portion thereof; however, the housing may have more than four surfaces. For example, as illustrated in FIG. 7, the housing may have eight surfaces continuous in the entire circumferential direction of the side portion thereof.

A housing 50c illustrated in FIG. 7 is formed in an octagonal shape in top view, and has octagonal top and bottom surfaces, and eight side surfaces facing the front, rear, left, and right and in oblique directions therebetween. The front, rear, left, and right side surfaces and oblique side surfaces therebetween of the housing 50c each include a vertical surface substantially vertical to a horizontal plane.

As illustrated in FIG. 7, similarly to the housing 50b, openings 51-1, 51-2 are arranged in the front side surface of the housing 50c, and openings 52-1, 52-2 are arranged in the left side surface of the housing 50c. Furthermore, although not illustrated, openings 53-1, 53-2 are arranged in the rear side surface of the housing 50c, and openings 54-1, 54-2 are arranged in the right side surface of the housing 50c. Note that in the example of FIG. 7, one opening may be arranged in each of the side surfaces at the front, rear, left, and right.

As described above, in the housing 50c having the eight side surfaces, the openings may be arranged in at least the front, rear, left, and right side surfaces of the housing 50c. Note that in the example of FIG. 7, for example, one opening may be arranged in each of the four oblique side surfaces in addition to the side surfaces at the front, rear, left, and right side surfaces of the housing 50c. Furthermore, in the example of FIG. 7, for example, one opening may be arranged in each of only the four oblique side surfaces excluding the side surfaces at the front, rear, left, and right of the housing 50c. Moreover, also in the example of FIG. 7, it is sufficient if the opening area on each of the side surfaces of the housing is the same even if the number of openings arranged in each of the side surfaces is different from one another.

### 4. Arrangement Place and Opening Area of Opening

Here, the arrangement place and opening area of the opening arranged on each side surface of the housing will be examined.

### Arrangement Place of Opening

First, by taking the housing 50a of FIG. 5 as an example, the arrangement places of the openings will be examined.

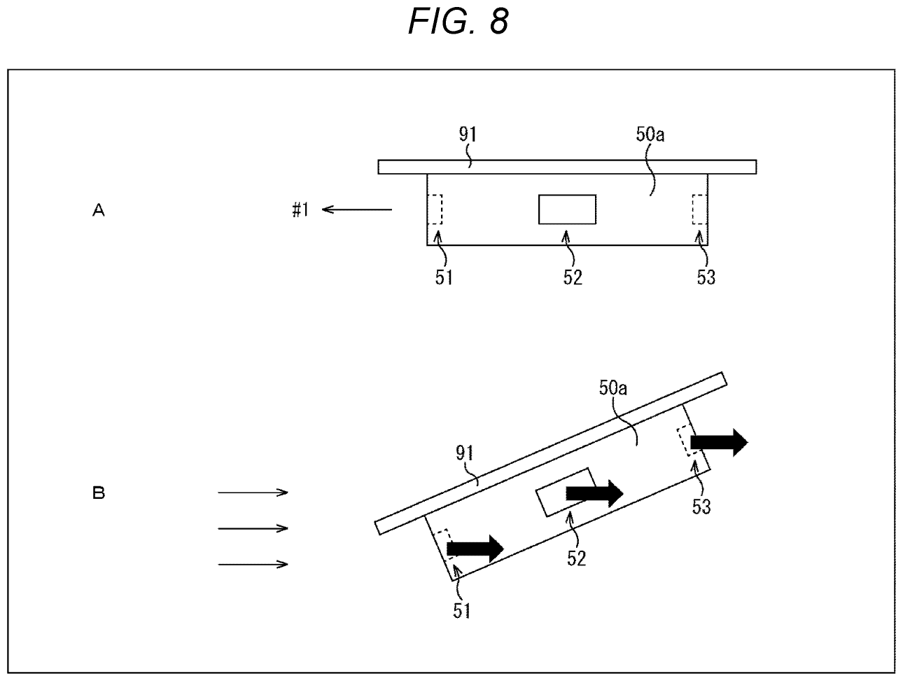

A of FIG. 8 illustrates a side view of the housing 50a of the drone 1 flying in the forward direction (the direction of the arrow #1). Eaves 91 are provided on the top surface of the housing 50a of FIG. 8 in addition to the configuration illustrated in FIG. 5. The eaves 91 are formed so as to largely protrude from the side surface of the housing 50a.

In the state of A, wind from the front of the drone 1 flows into the housing 50a through the opening 51 and flows out from the openings 52, 53, and 54 (not illustrated). In this case, the barometric pressure inside the housing 50a is in a stable state in which the positive pressure and the negative pressure are balanced.

However, as illustrated in B, in a case where the attitude of the drone 1 changes so as to incline forward with respect to the forward direction, the eaves 91 obstruct the inflow of wind through the opening 51. In such a case, as indicated by black block arrows in the drawing, wind only flows out from the openings 51 to 54, and the barometric pressure inside the housing 50a fluctuates due to an increase in the negative pressure.

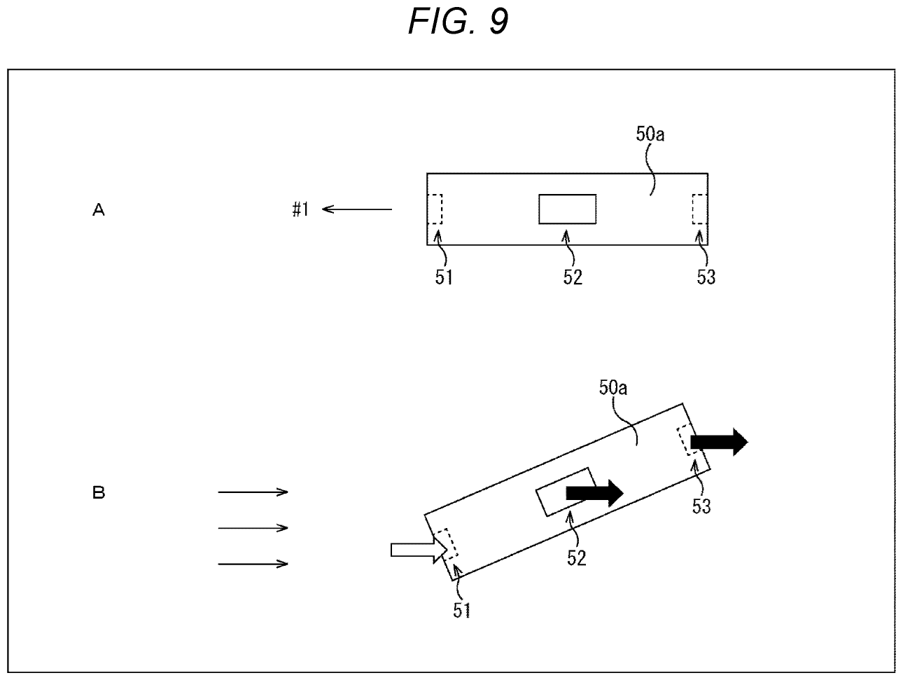

A of FIG. 9 illustrates a side view of the housing 50a of the drone 1 flying in the forward direction (the direction of the arrow #1). Similarly to the configuration illustrated in FIG. 5, the eaves 91 in FIG. 8 are not provided on the top surface of the housing 50a of FIG. 9.

In the state of A, wind from the front of the drone 1 flows into the housing 50a through the opening 51 and flows out from the openings 52, 53, and 54 (not illustrated). In this case, the barometric pressure inside the housing 50a is in a stable state in which the positive pressure and the negative pressure are balanced.

Moreover, as illustrated in B, even in a case where the attitude of the drone 1 changes so as to incline forward with respect to the forward direction, wind from the front of the drone 1 flows into the housing 50a through the opening 51 (white block arrow) without being obstructed by the eaves 91 as in the configuration of FIG. 8, and flows out from the openings 52, 53, and 54 (not illustrated) (black block arrows). That is, even in such a case, the barometric pressure inside the housing 50a is in a stable state in which the positive pressure and the negative pressure are balanced.

From the above, it is preferable that the opening arranged in each of the side surfaces of the housing is arranged at a place which does not obstruct ventilation between the outside of the housing and the space inside the housing during flight. In other words, it is preferable that a structure that might obstruct ventilation between the outside of the housing and the space inside the housing during flight is not arranged around the opening.

### Opening Area of Opening

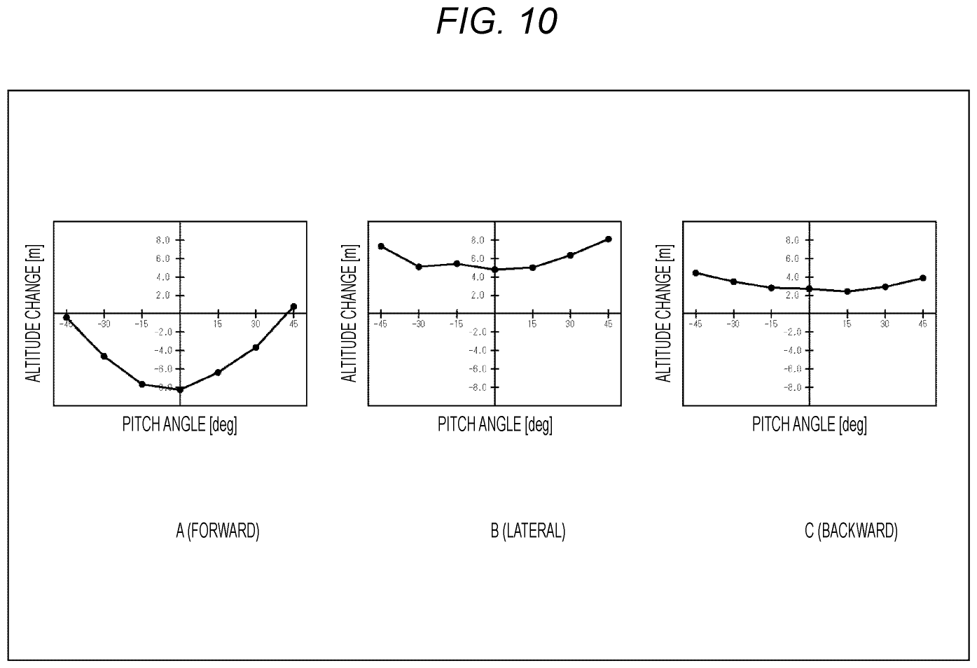

FIG. 10 is a diagram for explaining an altitude change in a case where the opening area of the openings arranged in the side surfaces of the housing is non-uniform.

FIG. 10 illustrates an altitude change for each attitude of the housing in a case where the opening area of the opening in the front side surface among the openings arranged in the side surfaces at the front, rear, left, and right of the housing is larger than the opening area of each of the openings in the other side surfaces (rear side surface, left and right side surfaces). The altitude change represents a variation in pressure altitude caused by a change in barometric pressure inside the housing due to inflow of wind into the housing.

Specifically, A of FIG. 10 illustrates a simulation result of the altitude change in a case where the pitch angle (in other words, the angle at which wind hits the opening) with respect to the traveling direction is changed while the drone 1 is flying in the forward direction. B illustrates a simulation result of the altitude change in a case where the pitch angle with respect to the traveling direction is changed while the drone 1 is flying in a lateral direction (leftward direction or rightward direction). C illustrates a simulation result of the altitude change in a case where the pitch angle with respect to the traveling direction is changed while the drone 1 is flying in a backward direction.

According to A, in a case where the drone 1 is flying in the forward direction, if the pitch angle is 0 degrees, the altitude change takes the maximum value (about −8.0 m) on the negative side, and every time the pitch angle is changed, the altitude change decreases (approaches 0 m). This can be considered that if the pitch angle is 0 degrees, the wind hits the opening of the front side surface from the front, the opening having a larger opening area than the area of each of the other openings, and therefore the barometric pressure inside the housing increases, leading to a decrease in the pressure altitude.

According to B, in a case where the drone 1 is flying in the lateral direction, the altitude change takes a value on the positive side (approximately between 4.0 m and 8.0 m) for any pitch angle.

According to C, in a case where the drone 1 is flying in the backward direction, the altitude change takes a value on the positive side (approximately between 2.0 m and 4.0 m) for any pitch angle.

As described above, in a case where only the opening area of the opening in the front side surface is increased among the openings arranged in the side surfaces of the housing, the estimated variation in the pressure altitude for the changes in the traveling direction of the drone 1 in flight and the pitch angle (attitude of the drone 1 in flight) with respect to the traveling direction becomes as large as about 8.0 m at the maximum, and the sign of the variation in the barometric pressure change also differs depending on the traveling direction.

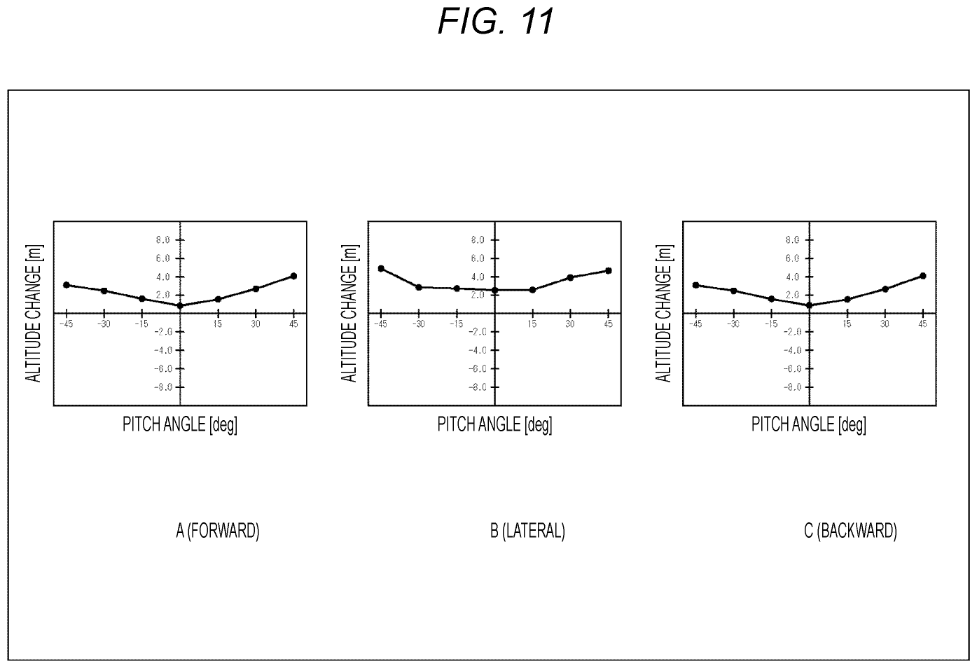

In contrast, FIG. 11 is a diagram for explaining an altitude change in a case where opening area of the opening in each of the side surfaces of the housing is uniform.

FIG. 11 illustrates an altitude change with respect to each attitude of the housing in a case where the opening area of all the openings arranged in side surfaces at the front, rear, left, and right of the housing is the same.

A, B, and C of FIG. 11 illustrate simulation results of the altitude change with respect to the pitch angle under the same conditions as those in A, B, and C of FIG. 10, respectively.

According to A, in a case where the drone 1 is flying in the forward direction, the altitude change takes a value on the positive side (approximately between 1.0 m and 4.0 m) with the value at the pitch angle of 0 degrees smallest.

According to B, in a case where the drone 1 is flying in the lateral direction, the altitude change takes a value on the positive side (approximately between 2.0 m and 5.0 m) for any pitch angle.

According to C, in a case where the drone 1 is flying in the backward direction, the altitude change takes a value on the positive side (approximately between 1.0 m and 4.0 m) with the value at the pitch angle of 0 degrees smallest.

As described above, in a case where the opening area of all the openings in the side surfaces of the housing is the same, it is possible to make the estimated variation in the pressure altitude for changes in the traveling direction of the drone 1 in flight and the pitch angle with respect to the traveling direction smaller than that in the example of FIG. 10, and to make the sign of the variation in the barometric pressure change for any traveling direction positive. That is, it is possible to limit the variation in the pressure altitude for the speed change, the attitude change, and the change in the traveling direction of the drone 1 to an easily predictable behavior.

From the above, it is preferable that the opening area of the openings arranged in each of the side surfaces of the housing is uniform.

### Actual Measurement Value of Pressure Altitude

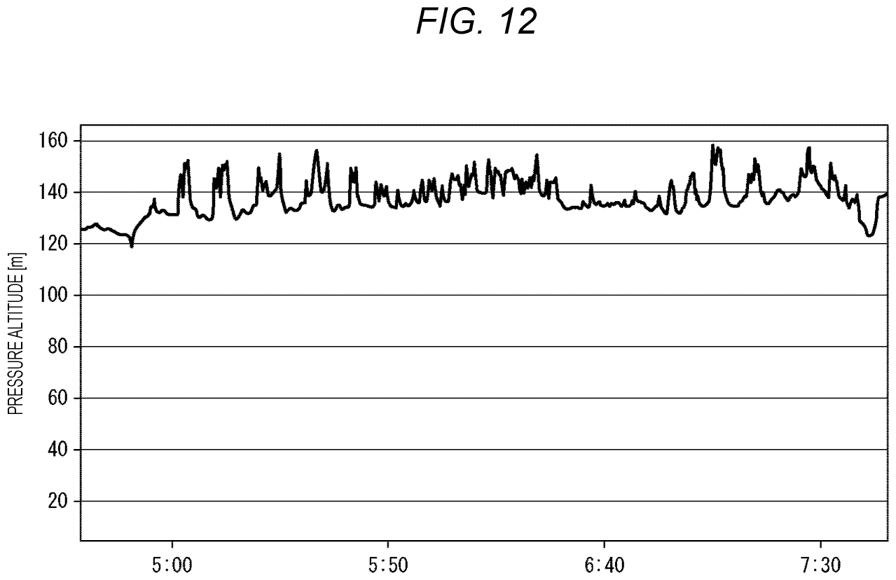

FIG. 12 is a diagram illustrating an actual measurement value of the pressure altitude in a conventional drone in which the number of openings in the front and rear side surfaces and the number of openings in the left and right side surfaces among the openings arranged in the side surfaces of the housing are different from each other.

In FIG. 12, the horizontal axis represents the flight time, and the vertical axis represents the pressure altitude based on the output value of the barometric pressure sensor. FIG. 12 illustrates the pressure altitude from 5.00 seconds to 7.30 seconds in the flight time of the drone. In the example of FIG. 12, it is assumed that the drone is flying at a flight speed of 5 m/s while changing its attitude and traveling direction.

According to FIG. 12, in the conventional drone, it can be confirmed that a variation in pressure altitude of about 20 m occurs in any flight state.

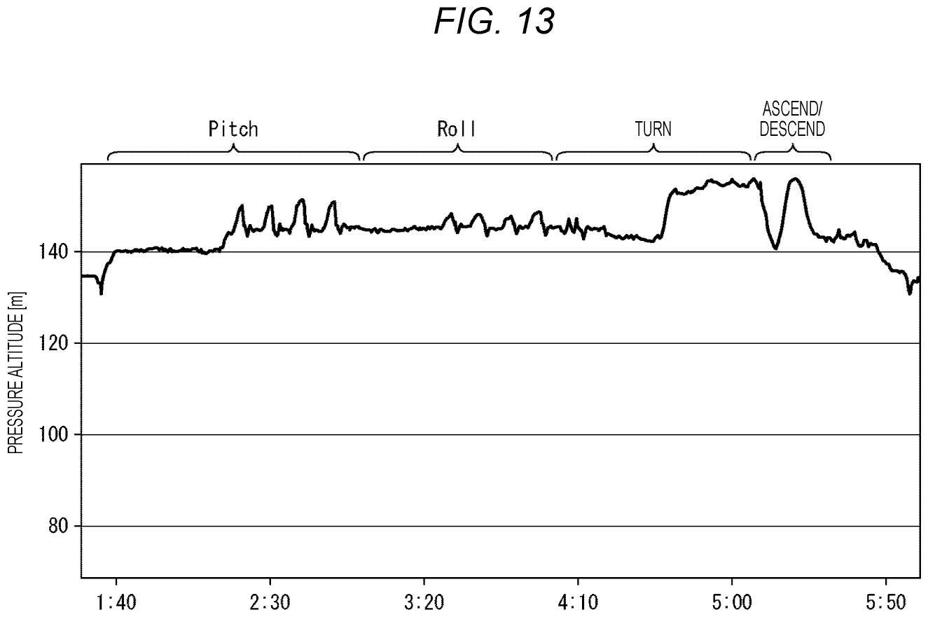

FIG. 13 is a diagram illustrating actual measurement values of the pressure altitude in the drone according to the present embodiment in which the number and opening area of openings arranged in each of the side surfaces of the housing are the same.

FIG. 13 illustrates the pressure altitude from 1.40 seconds to 5.50 seconds in the flight time of the drone. In the example of FIG. 13, it is assumed that the drone flies at a flight speed of 20 m/s while changing the attitude between pitch and roll with respect to the forward direction, and further flies while decreasing the flight speed to 12 m/s and changing the traveling direction from turn to ascend/descend.

According to FIG. 13, in the drone according to the present embodiment, it can be confirmed that the variation in the pressure altitude is limited to about 6 m in the case of pitch, about 3 m in the case of roll, and about 2 m even in the case of the turn while the drone is flying at a higher flight speed than that in the example of FIG. 12.

As described above, according to the housing to which the present technology is applied, it is possible to reduce the influence of disturbance such as a speed change, an attitude change, and a change in the traveling direction of the drone, and to make a variation in the pressure altitude have the same sign for any traveling direction, to limit the variation to a behavior to which numerical adjustment is made easily, and to suitably limit the variation in the pressure altitude.

### 5. Modifications

Hereinafter, modifications of the above-described embodiment will be described.

In the above-described description, the housing constituting the main body of the drone 1 is formed in a substantially square shape (FIGS. 5 and 6) or an octagonal shape (FIG. 7) in top view, but may be formed in another shape.

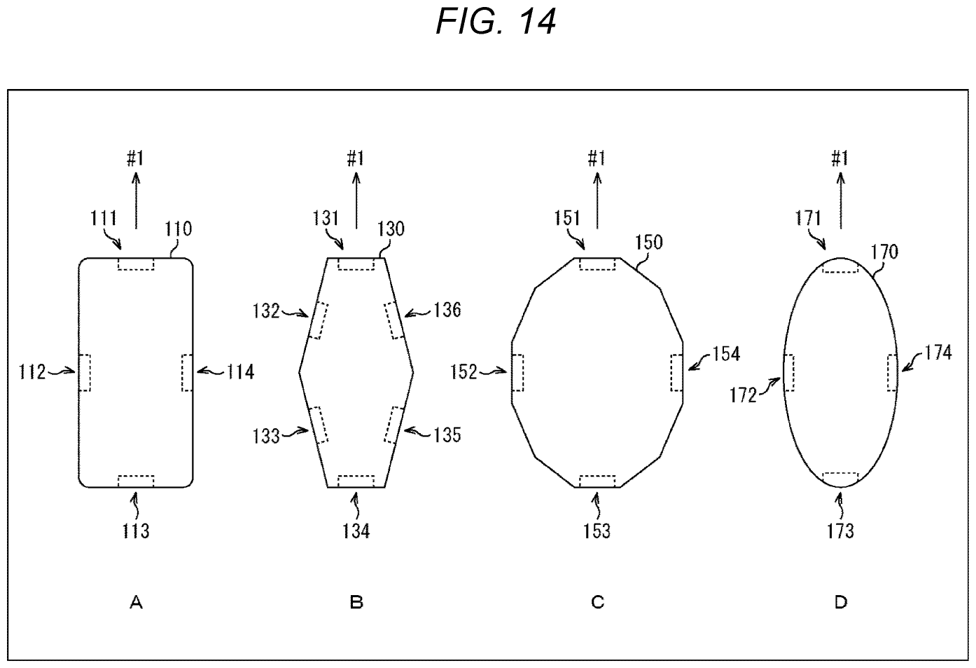

For example, as illustrated in A of FIG. 14, the housing of the drone 1 may be configured as a housing 110 having a rectangular shape long in the forward direction (the direction of the arrow #1) in top view and having four side surfaces facing the front, rear, left and right.

In this case, an opening 111 is arranged in the front side surface of the housing 110, an opening 112 is arranged in the left side surface of the housing 110, an opening 113 is arranged in the rear side surface of the housing 110, and an opening 114 is arranged in the right side surface of the housing 110.

Furthermore, as illustrated in B, the housing of the drone 1 may be configured as a housing 130 having a hexagonal shape long in the forward direction (the direction of the arrow #1) in top view and having six side surfaces facing the front and rear, diagonally forward left and right, and diagonally backward left and right.

In this case, an opening 131 is arranged in the front side surface of the housing 130, an opening 132 is arranged in the diagonally forward left side surface of the housing 130, and an opening 133 is arranged in the diagonally backward left side surface of the housing 130. Furthermore, an opening 134 is arranged in the rear side surface of the housing 130, an opening 135 is arranged in the diagonally backward right side surface of the housing 130, and an opening 136 is arranged in the diagonally forward right side surface of the housing 130.

Furthermore, as illustrated in C, the housing of the drone 1 may be configured as a housing 150 having a dodecagonal shape in top view and having twelve side surfaces facing twelve directions including the front, rear, left, and right.

In this case, an opening 151 is arranged in the front side surface of the housing 150, an opening 152 is arranged in the left side surface of the housing 150, an opening 153 is arranged in the rear side surface of the housing 150, and an opening 154 is arranged in the right side surface of the housing 150.

Note that, in the example of C, it is assumed that the openings are arranged only in the four side surfaces at the front, rear, left, and right of the housing 150; however, the openings may be arranged in the twelve side surfaces (all side surfaces).

Moreover, as illustrated in D, the housing of the drone 1 may be configured as a housing 170 having an elliptical shape in top view and having a band-like curved surface that goes around the side portion thereof.

In this case, in the curved surface constituting the side portion of the housing 170, an opening 171 is arranged at a place facing the front, an opening 172 is arranged at a place facing the left, an opening 173 is arranged at a place facing the rear, and an opening 174 is arranged at a place facing the right.

Note that as long as the openings arranged in the side portion of the housing 170 are arranged in a balanced manner over the entire circumference of the side portion, there may be more than the four openings facing the front, rear, left, and right.

Moreover, in each of the configurations of A to D of FIG. 14, it is sufficient if the opening area in each of the side surfaces of the housing is the same even if the number of openings arranged in each of the side surfaces is different.

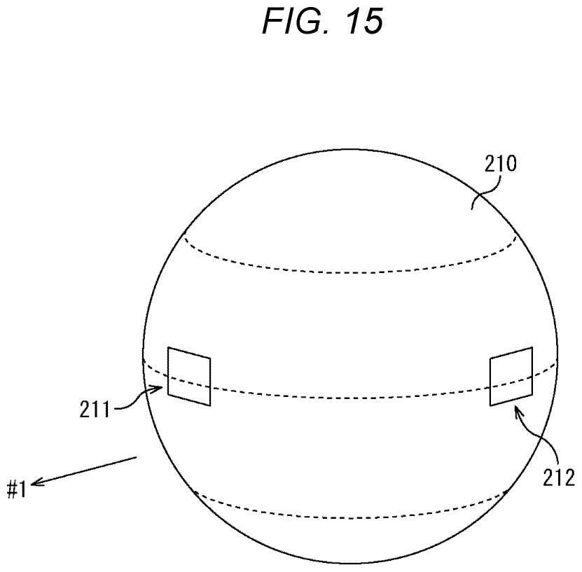

Furthermore, as illustrated in FIG. 15, the housing of the drone 1 may be configured as a housing 210 configured in a spherical shape. Note that the housing 210 may be configured in a completely spherical shape or may have a flat surface in part thereof.

In this case, the openings are arranged at equal intervals in the side portion of the spherical surface. Specifically, on a great circle corresponding to the equator of the spherical surface constituting the housing 210, an opening 211 is arranged at a place facing the front, and an opening 212 is arranged at a place facing the left. Furthermore, although not illustrated, an opening 213 is arranged at a place facing the rear, and an opening 214 is arranged at a place facing the right.

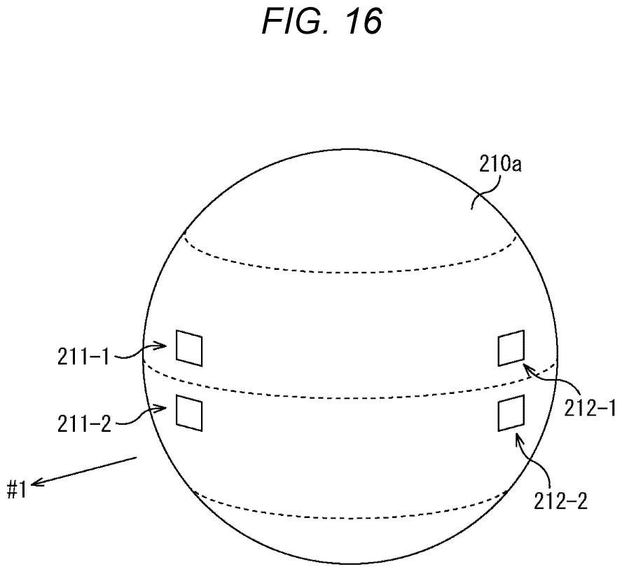

Furthermore, in the example of FIG. 15, it is assumed that one of the openings 211 to 214 is arranged at each of the places facing the front, rear, left, and right of the housing 210; however, it is sufficient if the same number of openings is arranged at each of the places facing the front, rear, left, and right. For example, as in a housing 210a illustrated in FIG. 16, two openings may be arranged in each of the places facing the front, rear, left, and right.

The housing 210a is also formed in a spherical shape.

Above and below a great circle corresponding to the equator of the spherical surface constituting the housing 210a, openings 211-1, 211-2 are arranged at places facing the front, and openings 212-1, 212-2 are arranged at places facing the left. Furthermore, although not illustrated, openings 213-1, 213-2 are arranged at places facing the rear, and openings 214-1, 214-2 are arranged at places facing the right.

Although not illustrated, the shape of the housing of the drone to which the present technology is applied is not limited to a spherical shape, and the housing may be formed in a prolate spheroid shape obtained by rotating an ellipse with its major axis as a rotation axis, or may be formed in an oblate spheroid shape obtained by rotating an ellipse with its minor axis as a rotation axis. Furthermore, the shape of the housing of the drone to which the present technology is applied is not limited to the above-described three-dimensional body, and the housing may be configured in any shape.

In the above description, it is assumed that the openings are arranged in the entire circumference of the side portion of the housing such as the side surfaces of the housing; however, the openings may also be arranged in the top surface and the bottom surface of the housing.

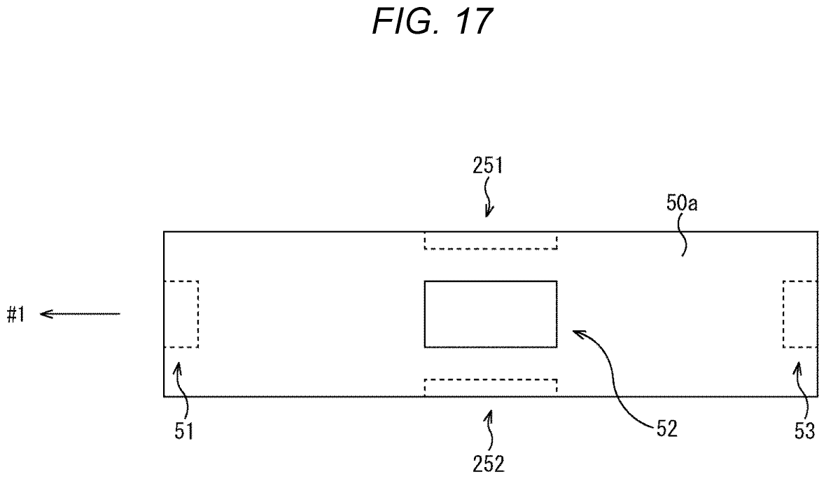

For example, as illustrated in FIG. 17, an opening 251 is arranged in the top surface of the housing 50a (FIG. 5) having a substantially square shape in top view, and an opening 252 is arranged in the bottom surface of the housing 50a.

It is assumed that the openings 251, 252 have the same opening area and the same shape; however, it is sufficient if at least the opening area of the openings 251, 252 is substantially the same. Moreover, each of the openings 251, 252 may have the same opening area and the same shape as those of each of the openings 51 to 54.

Note that, openings may be arranged in the top surface and the bottom surface of the housings according to the embodiment described above as well as the housing 50a.

Furthermore, in the housing of the drone to which the present technology is applied, it is assumed that the openings are arranged at the front, rear, left, and right of the housing as locations where ventilation can be performed in at least four directions based on the traveling direction of the drone in flight. However, it is sufficient if the openings are arranged in a balanced manner (in a well-balanced manner) over the entire circumference of the side portion of the housing. For example, the openings may be arranged at locations facing four directions, that is, a 45 degrees direction, a 135 degrees direction, a 225 degrees direction, and a 315 degrees direction with the forward direction as a reference (0 degrees).

The embodiments of the present technology are not limited to the above-described embodiments, and various modifications can be made without departing from the scope of the present technology.

In addition, the effects described in the present Description are illustrations only and not limited, and may have other effects.

Moreover, the present disclosure can also be configured as follows.

(1)

An unmanned aircraft including:

a housing that constitutes a main body;

one barometric pressure sensor that is provided in one space formed inside the housing; and

four or more openings that have substantially the same opening area, the four or more openings being arranged in a balanced manner over an entire circumference of a side portion of the housing.

(2)

The unmanned aircraft according to (1),

in which the openings are arranged at locations where ventilation can be performed in at least four directions based on the traveling direction during flight.

(3)

The unmanned aircraft according to (2),

in which the openings are arranged at least at the front, rear, left and right of the housing.

(4)

The unmanned aircraft according to (3),

in which the housing has four or more side surfaces continuous in an entire circumferential direction of the side portion, and

the openings are arranged in at least the side surfaces at the front, rear, left, and right of the housing.

(5)

The unmanned aircraft according to (4),

in which the same number of the openings is arranged in each of the side surfaces.

(6)

The unmanned aircraft according to (4) or (5),

in which the openings are arranged at the same locations in the side surfaces, respectively.

(7)

The unmanned aircraft according to any one of (4) to (6),

in which the openings are arranged in all of the side surfaces.

(8)

The unmanned aircraft according to any one of (4) to (7),

in which the housing has a rectangular shape in top view and has four of the side surfaces.

(9)

The unmanned aircraft according to (8),

in which the housing has a substantially square shape in top view.

(10)

The unmanned aircraft according to any one of (4) to (7),

in which the housing has an octagonal shape in top view and has eight of the side surfaces.

(11)

The unmanned aircraft according to (3),

in which at least part of the housing has a spherical shape, and

the openings are arranged at equal intervals in the side portion including a spherical surface.

(12)

The unmanned aircraft according to any one of (1) to (11),

in which the openings have the same opening area.

(13)

The unmanned aircraft according to any one of (1) to (12),

in which the openings have the same shape.

(14)

The unmanned aircraft according to any one of (1) to (13),

in which the openings are arranged at places that do not obstruct ventilation between the outside of the housing and the space during flight.

(15)

The unmanned aircraft according to any one of (1) to (14),

in which the openings have lattice covers that cover opening surfaces of the openings, respectively.

(16)

The unmanned aircraft according to any one of (1) to (15),

in which the openings are also arranged in a top surface and a bottom surface of the housing.

(17)

The unmanned aircraft according to any one of (1) to (16)

further including a windproof member that covers part or entirety of the periphery of the barometric pressure sensor.

(18)

The unmanned aircraft according to (17),

in which the windproof member includes sponge.

(19)

The unmanned aircraft according to (17),

in which the windproof member includes a case that has a vent hole.

(20)

The unmanned aircraft according to (19),

in which the case includes metal, resin, or fiber.

### REFERENCE SIGNS LIST

1 Drone

10 Main body

50 Housing

51 to 54 Opening

71 Substrate

72 Barometric pressure sensor

SP Space

WB Windproof member

1. An unmanned aircraft comprising:
a housing that constitutes a main body;
one barometric pressure sensor that is provided in one space formed inside the housing; and
four or more openings that have substantially same opening area, the four or more openings being arranged in a balanced manner over an entire circumference of a side portion of the housing.

2. The unmanned aircraft according to claim 1,
wherein the openings are arranged at locations where ventilation can be performed in at least four directions based on a traveling direction during flight.

3. The unmanned aircraft according to claim 2,
wherein the openings are arranged at least at a front, rear, left, and right of the housing.

4. The unmanned aircraft according to claim 3,
wherein the housing has four or more side surfaces continuous in an entire circumferential direction of the side portion, and
the openings are arranged in at least the side surfaces at the front, rear, left, and right of the housing.

5. The unmanned aircraft according to claim 4,
wherein a same number of the openings is arranged in each of the side surfaces.

6. The unmanned aircraft according to claim 4,
wherein the openings are arranged at same locations in the side surfaces, respectively.

7. The unmanned aircraft according to claim 4,
wherein the openings are arranged in all of the side surfaces.

8. The unmanned aircraft according to claim 4,
wherein the housing has a rectangular shape in top view and has four of the side surfaces.

9. The unmanned aircraft according to claim 8,
wherein the housing has a substantially square shape in top view.

10. The unmanned aircraft according to claim 4,
wherein the housing has an octagonal shape in top view and has eight of the side surfaces.

11. The unmanned aircraft according to claim 3,
wherein at least part of the housing has a spherical shape, and
the openings are arranged at equal intervals in the side portion including a spherical surface.

12. The unmanned aircraft according to claim 1,
wherein the openings have same opening area.

13. The unmanned aircraft according to claim 1,
wherein the openings have a same shape.

14. The unmanned aircraft according to claim 1,
wherein the openings are arranged at places that do not obstruct ventilation between an outside of the housing and the space during flight.

15. The unmanned aircraft according to claim 1,
wherein the openings have lattice covers that cover opening surfaces of the openings, respectively.

16. The unmanned aircraft according to claim 1,
wherein the openings are also arranged in a top surface and a bottom surface of the housing.

17. The unmanned aircraft according to claim 1
further comprising a windproof member that covers part or entirety of a periphery of the barometric pressure sensor.

18. The unmanned aircraft according to claim 17,
wherein the windproof member includes sponge.

19. The unmanned aircraft according to claim 17,
wherein the windproof member includes a case that has a vent hole.

20. The unmanned aircraft according to claim 19,
wherein the case includes metal, resin, or fiber.
